(19) United States
(12) Patent Application Publication
(10) Pub. No.: US 2020/0118139 A1
(43) Pub. Date: Apr. 16, 2020

(54) INTERCHANGE FEE PROCESSING METHODS AND SYSTEMS FOR CARD BASED PAYMENT TRANSACTIONS

(71) Applicant: Mastercard International Incorporated, Purchase, NY (US)

(72) Inventors: Shrinivas Ambadas Kalvit, Pune (IN); Rohit Kulkarni, Pune (IN)

(73) Assignee: Mastercard International Incorporated, Purchase, NY (US)

(21) Appl. No.: 16/242,589

(22) Filed: Jan. 8, 2019

(30) Foreign Application Priority Data
Oct. 12, 2018 (SG) 10201809003S

(51) Int. Cl. G06Q 20/40; G06Q 20/06

(52) U.S. Cl. CPC G06Q 20/4093; G06Q 20/401; G06Q 20/06; G06Q 20/405

(57) ABSTRACT

Systems and methods for determining interchange rate designator (IRD) values are provided. A microservice, provided at acquiring servers to determine the IRD value, receives a transaction clearing service request from acquiring servers. The transaction clearing service request includes details of payment card and details of payment transaction. The microservice validates the details of a payment card and the card payment transaction. Based on the details, the microservice identifies a card program identifier (CPI) and product ID associated with the payment card from a member parameter extract data. The microservice identifies business service arrangements (BSAs) applicable on the payment transaction based on the CPI, the details of the payment card and the details of the card payment transaction. The microservice validates each BSA and determines one or more IRD values for each validated BSA, and further validates each IRD value and determines an optimal IRD value from the validated IRD values.

### CROSS REFERENCE TO RELATED APPLICATIONS

This application claims priority to Singaporean Application Serial No. 10201809003S, filed Oct. 12, 2018, which is incorporated herein by reference in its entirety

### TECHNICAL FIELD

The present disclosure relates to interchange fee processing in card payment transactions and, more particularly to, methods and systems for facilitating determination of the interchange fee for the card payment transactions.

### BACKGROUND

Card payment transactions have enabled cashless payments for the purchase of goods and service. The cashless payment comes as a convenient and hassle-free way of purchasing but there is always a risk to security. In order to facilitate card-based payment transaction between the issuing and acquiring institutions, an interchange fee is introduced for the card payment process and the interchange fee is normally paid by the acquiring institution. Interchange fees have a complex pricing structure, which is based on the brand of the card, jurisdictions or regions, the type of credit or debit card, the type of the merchant, the type of transactions (e.g., online or in-store, etc.) and some more business parameters.

Interchange fee is associated with a concept called interchange rate designator (IRD) value. The IRD value is a two-position code that indicates the interchange rate and rules applied to the transaction. The acquiring banks are responsible for calculating the correct IRD value for each transaction. These IRD values along with other ISO parameters are given to a payment processing network such as Mastercard® etc. The payment servers calculate the interchange fee based on the given IRD value and ISO parameters, and provides information of this amount to the issuing server.

The determination of the IRD value for each specific transaction is a very complex process because it depends on a plurality of factors such as different business arrangements, interchange programs, timeliness requirements, merchant category, transaction types, card technology, terminal capability, authentication factors and some more business parameters, and needs large lookup data making it quite difficult for acquirers to build accurate solution to compute IRD value. Acquirers also need to incorporate changes for any new products and business rules introduced as a part of mandates. Any incorrect submission or delayed submission of IRD values lead to fees with higher interchange rates which is a financial loss for acquirers, as acquirers configure commissions, commonly known as Merchant Discount Rate (MDR), to be levied from the merchant with respect to interchange fee rates. Hence, there is a need for techniques for computation of optimal IRD value and fees that can be used globally by any acquiring institution in any country and region across the world, so as to facilitate hassle-free integration with the card clearing network system.

### SUMMARY

Various embodiments of the present disclosure provide methods and systems for computing interchange rate designator (IRD) value for interchange rate processing.

In an embodiment, a method of computing interchange rate designator (IRD) value for interchange rate processing in payment transactions by payment cards, is disclosed. The method includes receiving at least one transaction clearing service request comprising at least a payment card information and a set of transaction details. The method further includes identifying a card program identifier (CPI) and a license product identifier (ID) associated with the payment card from a member parameter extract data based on the payment card information and the set of transaction details. The method further includes identifying one or more business service arrangements (BSA) that are applicable on the payment transactions based on the CPI, the payment card information and the set of transaction details. The method further includes validating each BSA of the one or more BSAs based on at least one of a first set of validation parameters, and upon successful validation, determining at least one IRD value for the BSA. The method further includes validating each IRD value of the at least one IRD value based on at least one of a second set of validation parameters and selecting an optimal IRD value from validated IRD values for the one or more BSAs based on an IRD selection rule.

In another embodiment, a method is disclosed. The method includes receiving at least one transaction clearing service request comprising at least a payment card information and a set of transaction details. The method further includes identifying a card program identifier (CPI) and a license product identifier (ID) associated with a payment card from a member parameter extract data based on the payment card information and the set of transaction details. The method further includes identifying one or more business service arrangements (BSAs) that are applicable on the payment transaction based on the CPI, the payment card information and the set of transaction details. The method further includes validating each BSA of the one or more BSAs based on at least one of a first set of validation parameters, and upon successful validation, determining at least one IRD value for the BSA. The method further includes validating each IRD value of the at least one IRD value based on at least one of a second set of validation parameters. The method further includes identifying a delay in reception of a transaction clearing service request based on late submission of the transaction clearing service request; and computing a delayed IRD value for the IRD value based on the delay in reception of the transaction clearing service request. The method further includes selecting an optimal IRD value from one of the validated IRD values and the delayed IRD values for the one or more BSAs based on an IRD selection rule.

In another embodiment, a microservice system for performing interchange rate processing is disclosed. The microservice system includes a memory to store instructions, and at least one processor configured to execute the stored instructions to cause the microservice system to perform at least: receiving at least one transaction clearing service request comprising at least a payment card information and a set of transaction details. The at least one processor further cause the microservice system to perform at least: identifying a card program identifier (CPI) and a license product identifier (ID) associated with a payment card from a member parameter extract data based on the payment card information and the set of transaction details. The method includes identifying one or more business service arrangements (BSAs) that are applicable on the payment transactions based on the CPI, the payment card information and the set of transaction details. The method includes validating a BSA of the one or more BSAs based on at least one of a first set of validation parameters, and upon successful validation, determining at least one IRD value for the BSA. The method includes validating an IRD value of the at least one IRD value based on at least one of a second set of validation parameters. The method includes selecting an optimal IRD value from validated IRD values for the one or more BSAs based on an IRD selection rule.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 illustrates a sequence flow diagram representing a method of computation and transmission of IRD value for each card payment transaction, in accordance with an example embodiment;

FIG. 3 illustrates simplified block diagram of a microservice system used for determination of IRD value associated with the card payment transaction using payment card, in accordance with an example embodiment;

FIGS. 4A, 4B illustrate a flow diagram representing a method of computation of IRD value by the microservice for each card payment transaction, in accordance with an example embodiment;

FIG. 5 illustrates a flow diagram representing a method of computation of IRD value, in accordance with another example embodiment;

FIG. 6 illustrates a simplified block diagram of a merchant terminal such as the POS terminal used for transactions, in accordance with an example embodiment;

FIG. 7 illustrates a simplified block diagram of an issuing server, in accordance with an example embodiment;

FIG. 8 illustrates a simplified block diagram of an acquiring server, in accordance with an example embodiment; and

FIG. 9 illustrates a simplified block diagram of a payment server, in accordance with an example embodiment

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuing server” used throughout the description refers to a server that holds a financial account that is used to fund the financial transaction (interchangeably referred to as “card payment transaction”) of a cardholder. Further, the term “acquiring server” used throughout the description refers to a server that holds a financial account of a merchant or any entity which receives the fund from the issuing server. Examples of the issuing server and the acquiring server include, but are not limited to a bank, electronic payment portal such as PayPal®, and a virtual money payment portal. The financial accounts in each of the issuing server and the acquiring server may be associated with an entity such as an individual person, a family, a commercial entity, a company, a corporation, a governmental entity, a non-profit organization and the like. In some scenarios, the financial account may be a virtual or temporary payment account that can be mapped or linked to a primary payment account, such as those accounts managed by PayPal®, and the like.

The term “payment card”, used throughout the description, refers to a physical or virtual card linked with a financial or payment account that may be presented to a merchant or any such facility in order to fund a financial transaction via the associated payment account. Examples of the payment card includes, but are not limited to, debit cards, credit cards, prepaid cards, digital wallet, virtual payment numbers, virtual card numbers, forex card, charge cards and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

The term “network”, used throughout the description, refers to a network or collection of systems used for transfer of funds through use of cash-substitutes. Networks may use a variety of different protocols and procedures in order to process the transfer of money for various types of transactions. Transactions that may be performed via a network may include product or service purchases, credit purchases, debit transactions, fund transfers, account withdrawals, etc. Networks may be configured to perform transactions via cash-substitutes, which may include payment cards, letters of credit, checks, financial accounts, etc. Examples of networks or systems configured to perform as networks include those operated by MasterCard®, VISA®, Discover®, American Express®, etc.

Other aspects and example embodiments are provided in the drawings and the detailed description that follows.

### Overview

Various example embodiments of the present disclosure provide methods and systems for computation of IRD values for card-based payments between entities such as acquiring banks of merchants and issuer banks of cardholders (customers). Embodiments facilitate a microservice that can be associated with acquiring servers or merchant systems for the computation of the IRD values, and the computed IRD values are provided to the payment server for calculation of interchange fee for the payment transaction. Embodiments of the present invention facilitates calculation of the IRD values locally by the acquiring servers using the microservice.

The microservice receives a transaction clearing service request from the acquiring server for a current payment transaction. The microservice identifies a card program identifier (CPI) and a license product identifier (ID) associated with the payment card from a member parameter extract (MPE) data based on the payment card information and the set of transaction details present in the transaction clearing service request. The microservice is further configured to identify one or more business service arrangements (e.g., BSAa, BSAb, BSAc) that are applicable on the current payment transaction based on the CPI, the payment card information and the set of transaction details. For each of the BSA, BSA and CPI combinations are validated based on a first set of validation parameters, and applicable IRD values are identified. For example, if a BSA i.e. BSAa is validated for the first set of parameters, applicable IRD values such as IRD1a, IRD2a and IRD3a are identified. Further, each of the IRDs is selected in a sequential manner, and is validated on the basis of a second set of parameters. Once, the selected IRD value (e.g., IRD2) is validated for the second set of parameters, the IRD value i.e. IRD2 is selected for calculating the interchange fee.

In an example, if none of the IRD values determined for the selected BSA i.e. BSAa are validated based on the second set of parameters, the next BSA i.e. the BSAb is selected. Further, the BSAb is validated based on the first set of parameters, and if validated, applicable IRD values such as IRD1b, IRD2b and IRD3b are determined. Further, each of the IRD1b, IRD2b and IRD3b are selected in a sequential manner, and is validated on the basis of the second set of parameters. Once, the selected IRD value (for example, IRD1b) is validated for the second set of parameters, the IRD value i.e. IRD1b is considered as a derived IRD and is selected for calculating the interchange fee by the payment server.

In some example embodiments, all of the IRD values that are applicable to the identified BSAs, are validated based on the second set of parameters, and multiple IRD values are derived. From the multiple IRD values, an optimal IRD value may be selected based on a selection rule. An example of the selection rule includes selecting an IRD value which provides the minimum interchange fee for the current payment transaction. Additionally or optionally, wherever applicable, the microservice is also configured to determine a delayed IRD value for the derived optimal IRD value, if there is a delay in sending the transaction clearing service request from the acquiring server. The optimal IRD may be used for computation of the interchange fee.

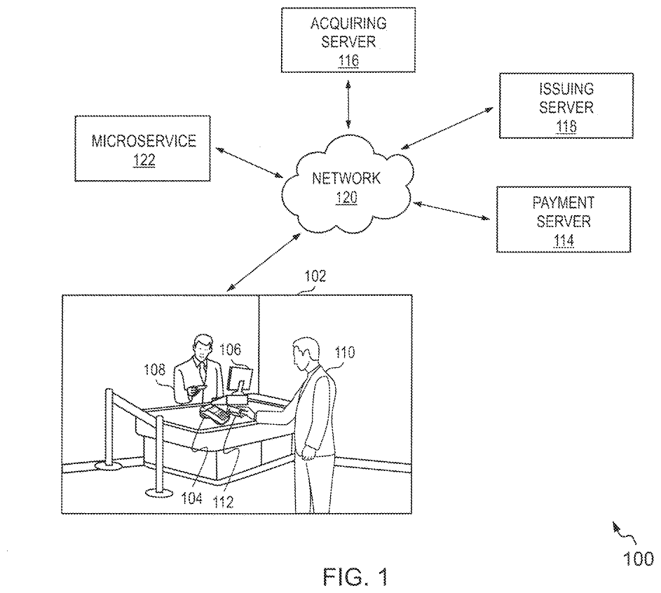

FIG. 1 illustrates an exemplary representation of an environment 100, in which at least some example embodiments of the present disclosure can be implemented. The environment 100 is exemplarily shown as a merchant facility 102 (also referred to herein as ‘a merchant 102’) equipped with a merchant terminal 104 and a merchant interface device 106. Examples of the merchant facility 102 may include any retail establishments such as, restaurant, supermarket or business establishments such as, government and/or private agencies, toll gates, parking lot or any such place equipped with merchant terminal 104, such as a POS terminal (as shown in FIG. 1 in a non-limiting exemplary manner), an e-commerce terminal and the like, where customers visit for performing financial transaction in exchange for any goods and/or services or any transaction that requires financial transaction between customers and a merchant. In various embodiments, the merchant interface device 106 can be a telephone or a computer system operated by an agent 108 for performing payment transactions on behalf of a customer, for example, a cardholder 110 using a payment card 112.

In the card payment transaction process, the cardholder 110 offers to pay for the goods purchased at the merchant 102 using the payment card 112. The cardholder 110 hands over the payment card 112 to the agent 108 at the POS terminal 104. A card reader module in the POS terminal 104 is configured to read payment card information of the payment card 112 for the transaction. The POS terminal 104 displays a prompt requesting the cardholder 110 to provide a PIN for authorizing the transaction using the payment card 112. For example, when the agent 108 swipes the payment card 112 at the POS terminal 104, the card reader module reads the payment card information and prompts the cardholder 110 to provide the PIN for validating the transaction. The cardholder 110 provides the PIN on the POS terminal 104. The merchant terminal 104 sends transaction details to an acquiring server 116. The transaction details include the payment card information, the PIN and a transaction amount among other details such as merchant identifier and merchant account details. The acquiring server 116 forwards the transaction details to a payment server 114. The payment server 114 sends the payment card information and the PIN to an issuing server 118 for verification. The issuing server 118 verifies whether the PIN received from the payment server 114 is an actual PIN linked to an associated issuer account of the cardholder 110 for which the payment card 112 was issued to the cardholder 110. The issuing server 118 further checks the account balance of the issuer account and whether the account balance is enough to accommodate the transaction amount. Based on these determinations, the transaction request may be facilitated. The issuing server 118 sends a transaction approval or decline notification/message to the payment server 114. The payment server 114 sends the transaction approval or decline notification/message to the acquiring server 116. The acquiring server 116 sends the transaction approval or decline notification/message to the POS terminal 104. The POS terminal 104 generates a bill or a receipt for transaction. The bill may include the transaction amount, taxes, transaction date, POS ID information, issuing bank name and acquiring bank name, among other information. The bill is printed at the POS terminal 104. The bill is handed over to the cardholder 110.

The payment server 114 facilitates the card payment transaction by the transfer of information between the acquiring server 116 and the issuing server 118 via a network 120 and also enables authorization of the payments between the acquiring server 116 and the issuing server 118. In card payment processing between the cardholder 110 and the merchant 102, the merchant 102 is levied with an interchange fee for using the card payment service. The interchange fee is paid to the issuing server 118 to cover the fraudulence risks, bad debt costs, and transaction authentication/approvals costs involved in the card payment transaction. The payment server 114 computes an interchange fee applicable on each successful card payment transaction conducted between the acquiring server 116 and the issuing server 118. The payment server 114 determines the interchange fee based on an IRD value that is provided by the merchant facility 102 for each card payment transaction.

A microservice 122 is rendered at the merchant 102 and/or the acquiring server 116 as a web or a mobile application interface (also referred to as an ‘application interface’) to facilitate determination of the IRD value for each successful card payment transaction. Alternately, the microservice 122 may also be a standalone server system configured to facilitate determination of the IRD value for each successful card payment transaction. The acquiring server 116 sends at least one transaction clearing service request related to the card payment transaction to the microservice 122 via the network 120. The transaction clearing service request includes details of the payment card 112 and details of the card payment transaction. The details of the payment card 112 comprises, among other information, a payment card number printed on the payment card 112. The details of the card payment transaction comprises, among other information, a request ID, acquirer reference number, transaction date, a message type indicator (MTI), Bank Identification Number (BIN) low, a transaction amount, a function code, a processing code, reversal indicator, message reason code, acquiring institution country, a point of sale (POS) data, a universal cardholder authentication field (UCAF) indicator, a service code, transaction currency code, a merchant category code (MCC), an approval code, and a clearing product identification (ID).

In application, the payment server 114 publishes periodically (or upon any change) a member parameter extract file comprising a plurality of data elements required for operations and business rules and publishes the member parameter extract file to all registered members including all the acquiring server 116 and the issuing server 118 associated with the payment server 114. The members download data from the published member parameter extract file according to their business requirement, on a periodic basis such as daily or weekly. The microservice 122 supports the member parameter extract file. The microservice 122 derives at least one data element from the plurality of data elements in the member parameter extract file based on the details of the payment card 112 and the details of the card payment transaction received in the transaction clearing service request. The plurality of data elements includes a brand product, currency codes, message reason codes, country codes, issuer account range, acquiring BIN, card acceptor business codes, masked interchange rate designators, masked business service, transaction functions requiring business service processing, geographical restrictions for CPI, BSA and IRD, or masked from account type. For example, the microservice 122 derives a license product ID based on mapping the clearing product ID within a table that comprises multiple brand products named against corresponding clearing product IDs, and the table is present in the member parameter extract data file. In another example, the microservice 122 derives the acquiring country region code and the issuing country region codes based on the country codes present in the member parameter extract data file. Similarly, the microservice 122 derives at least one data element from the plurality of data elements from the member parameter extract data file based on the details of the payment card 112 and the details of the card payment transaction.

The request ID is a unique identifier associated with each transaction request. The acquirer reference number indicates the acquiring bank's identification number (BIN). In an example, the MTI is a four-digit message which indicates ISO 8583 version, message class, message function and message origin. For example, given an MTI value of 0110, the following example lists what each position indicates:
First digit—0xxx→version of ISO 8583 (0=1987 version)
Second digit—x1xx→class of the message (1=authorization message)
Third digit—xx1x→function of the message (1=response)
Fourth digit—xxx0→who began the communication (0=acquirer)
   Therefore, MTI 0110 is an authorization response message sent by the acquiring server 116.

The BIN low corresponds to bank identification number of the card number belonging to issuing server 118. In an example, the function code indicates whether the transaction is a presentment or a re-presentment (partial re-presentment or full representment). In an example, the processing code is a six digit code in which first two digits indicate type of transaction such as purchase, money send etc. the next two digits indicate account type of the issuer and the last two digits indicate account type of the acquirer. The POS data indicates capability of the POS terminal 104, capability of the payment card and type of transaction such as whether the POS terminal 104 supports full UCAF, merchant UCAF, acquirer chip, issuer chip or standard, whether the payment card 112 is a chip card, a magnetic strip card etc., and whether the transaction happened by swiping the payment card 112 or by reading the payment card 112 using chip or by providing PIN of the payment card 112 or without providing the PIN of the payment card 112 etc. In an example, the MCC is a four-digit number listed in ISO 18245 for retail financial services. MCC is used to classify the business by the type of goods or services it provides. The message reason code is assigned to each reversal initiated by the acquiring server 116. These codes specify the reason why the transaction is reversed back. The transaction amount is the amount of money charged for the purchase made in the card payment transaction. The approval code corresponds to the approval given from the issuing server 118 to proceed with the card payment transaction. The clearing product ID is an identification code associated with the payment card 112 to derive at least one card program associated with the payment card 112.

The microservice 122 determines the applicable interchange fee for each card payment transaction based on the plurality of data elements, the details of the payment card 112 and the details of the card payment transaction. The microservice 122 shares the calculated IRD value to the acquiring server 116. The acquiring server 116 sends the received IRD value to the payment server 114. The payment server 114 is configured to calculate the interchange fee and shares the interchange fee with the merchant 102 and the payment server 114 transfers the amount equivalent to the interchange fee from the acquiring server 116 to the issuing server 118.

In an exemplary scenario, the microservice 122 can be a standalone server with which a plurality of acquiring servers 116 communicate to get the IRD values for respective card payment transactions. In some scenarios, the microservice 122 can be embodied within each of the acquiring servers 116. The plurality of acquiring servers 116 can register as a member with the microservice 122 to leverage the benefit of services provided by the microservice 122. The microservice 122 can allow access to the acquiring servers 116 based on login credentials provided to the plurality of acquiring servers 116 during registration. The microservice 122 selects at least one transaction clearing service request from at least one acquiring server from the plurality of acquiring servers 116 based on a priority given to each request by each acquiring server of the plurality of acquiring servers 116. The priority can be considered in accordance with a time the request was received by the microservice 122 such as first comes first serve basis or the priority can be given based on an urgency level associated with the request or the priority can be based on parameters like transaction type, transaction country or transaction amount. In some examples, the microservice 122 can perform a batch processing, and can cater to a request from multiple acquiring servers 116 to determine the IRD values in a parallel manner.

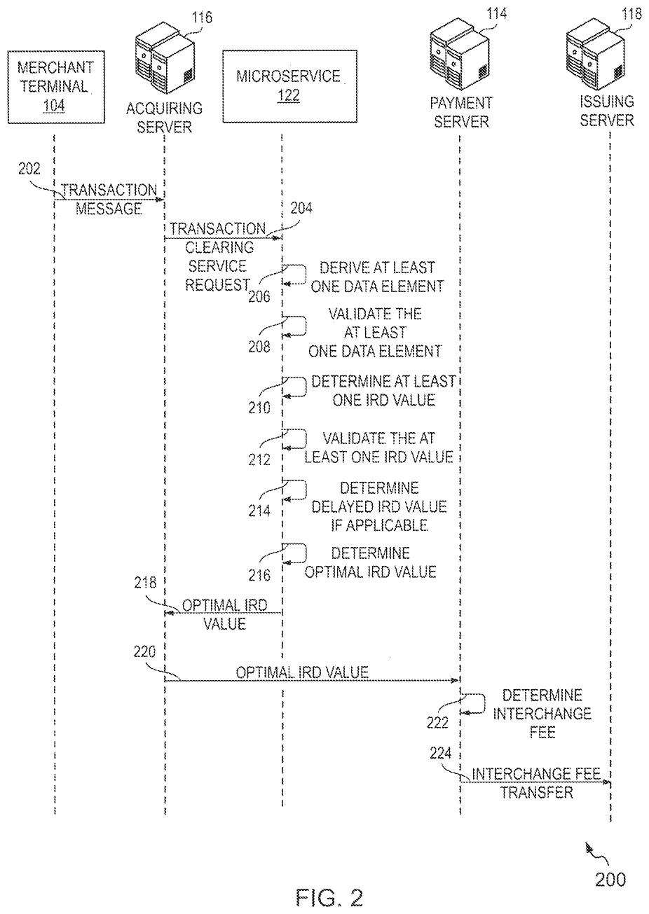

Referring now to FIG. 2, a sequence flow diagram 200 representing a method of computation and transmission of IRD value by the microservice 122 for each card payment transaction is illustrated in accordance with an example embodiment.

At 202, the merchant terminal 104 sends a message comprising details of the card payment transaction along with details of the payment card 112 to the acquiring server 116. At 204, the acquiring server 116 sends a transaction clearing service request associated with the card payment transaction to the microservice 122. The transaction clearing service request indicates a request for computing the IRD value for the card payment transaction. The transaction clearing service request includes details of the payment card 112 and details of the card payment transaction. The details of the payment card 112 includes a payment card number printed on the payment card 112. The details of the card payment transaction includes, among other information, a request ID, acquirer reference number, transaction date, a message type indicator (MTI), BIN low, a transaction amount, a function code, a processing code, reversal indicator, message reason code, acquiring institution country, a point of sale (POS) data, a universal cardholder authentication field (UCAF) indicator, a service code, transaction currency code, a merchant category code (MCC), an approval code, and a clearing product ID.

At 206, the microservice 122 derives at least one data element from the plurality of data elements in the member parameter extract (MPE) file based on the details of the payment card 112 and the details of the card payment transaction received in the transaction clearing service request. The plurality of data elements comprises, among other information, a brand product, currency codes, message reason codes, country codes, interchange amount restrictions, issuer account range, acquiring BIN, card acceptor business codes, masked interchange rate designators, masked business service, transaction functions requiring business service processing, geographical restrictions for CPI, BSA and IRD, or masked from account type. An example of the at least one data element includes a combination of the CPI and BSAs. For instance, for given acquiring BIN, card number and CPI, all possible BSAs (e.g., BSAa, BSAb, BSAc, etc.) are identified, and each combination of acquiring BIN, card number and CPI and BSA is considered as one data element.

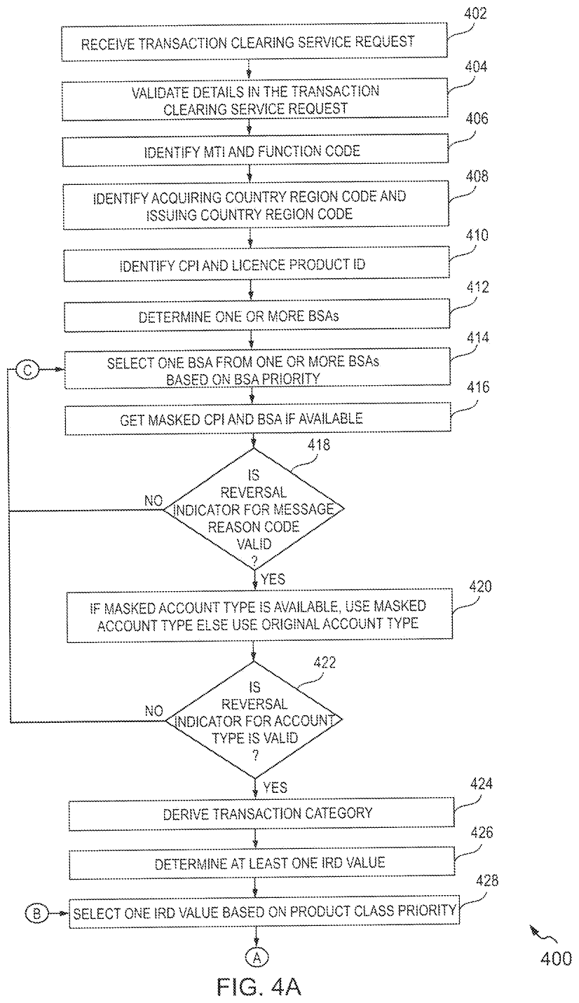

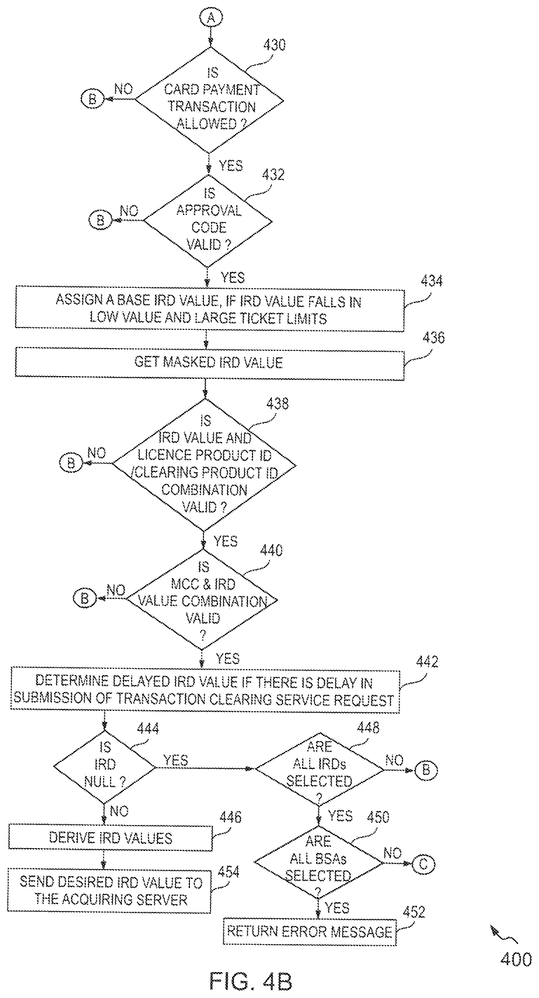

At 208, the microservice 122 validates the at least one data element of the plurality of data elements along based on a first set of parameters, which is described later with reference to FIG. 4. In an example embodiment, the validation of the data elements can be done in a sequential manner. For instance, in a first pass, validation of the combination of BIN, card number, CPI and BSAa may be performed, and thereafter a validation of the combination of BIN, card number, CPI and BSAb, and a combination of BIN, card number, CPI and BSAc may be performed, in a sequential manner.

At 210, the microservice 122 determines at least one IRD value applicable on the card payment transaction based on the derived at least one data element and validation results of the at least one data element based on the first set of parameters. For instance, in the first pass, applicable IRDs for BSAa or more precisely for the combination of BIN, card number, CPI and BSAa, are determined. Further, in the second pass, applicable IRDs for BSAb or more precisely for the combination of BIN, card number, CPI and BSAb, are determined. Thereafter, applicable IRDs for BSAc or more precisely for the combination of BIN, card number, CPI and BSAc, are determined. It should also be further noted that IRDs for all of the possible BSAs (BSAa, BSAb and BSAc) may be determined simultaneously or in sequential manner.

At 212, the microservice 122 validates the at least one IRD value based on at least one validation parameter from a second set of validation parameters. Validation of the IRD values may be done in a sequential manner or in parallel manner for all of the IRDs determined at operation 210. Examples of the second set of parameters are described later with reference to FIG. 4.

At 214, the microservice 122 determines whether there is a time delay in submission of the transaction clearing service request by the acquiring server 116. If there is time delay in submission of the transaction clearing service request by the acquiring server 116 then a delayed IRD value is calculated based at least on a base IRD value.

At 216, the microservice 122 determines an optimal IRD value from the at least one IRD value validated at step 212 and from the delayed IRD value determined at step 214. In an example embodiment, the optimal IRD value corresponds to a lowest rate IRD value from the at least one IRD value. The microservice 122 creates a static table including delayed IRD values placed in association with the optimal IRD value in accordance with the time delay in submission of transaction clearing service request by the acquiring server 116. In an embodiment, if the delayed IRD value is calculated, the optimal IRD value may be same as the delayed IRD value.

At 218, the microservice 122 transmits the optimal IRD value to the acquiring server 116. At 220, the acquiring server 116 sends the optimal IRD value to the payment server 114.

At 222, the payment server 114 determines an interchange fee for the card payment transaction based on the optimal IRD value.

At 224, after the payment transaction is effected, the interchange fee may be transferred back from the acquiring account linked with the acquiring server 116 to the issuer account linked with the issuing server 118.

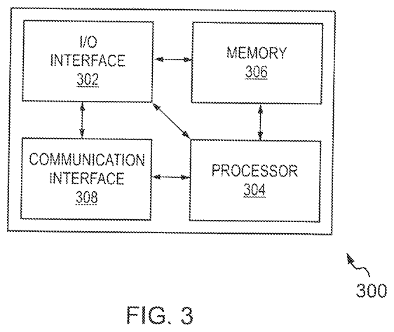

Referring to FIG. 3, a simplified block diagram of a server system such as a microservice system 300 used for determination of IRD value associated with the card payment transaction using the payment card 112, in accordance with one embodiment of the present disclosure. The microservice system 300 is an example of the microservice 122 shown in FIG. 1. The microservice system 300 includes an input/output (I/O) interface 302, a processor 304, a memory 306, and a communication interface 308. The one or more of the components in this example may be combined or may be replaced by the processor 304. The components described herein (e.g., the (I/O) interface 302, the processor 304, the memory 306, and the communication interface 308) may include hardware and/or software that are configured or programmed to perform the steps described herein.

The I/O interface 302 is configured to receive or transmit information between the microservice system 300 and outside devices such as the acquiring server 116, the payment server 114. The I/O interface 302 may receive the at least one transaction clearing service request from the acquiring server 116, via the network 120. The I/O interface 302 may further transmit an output information such as the IRD value to the payment server 114 via the network 120. For example, the I/O interface 302 may include a transceiver device (e.g., a modem, a microwave antenna), a remote command unit interface (RCU-IF) or any other types of I/O interface.

The transaction clearing service request indicates a request for computing the IRD value for the card payment transaction. The transaction clearing service request includes details of the payment card 112 and details of the card payment transaction. The details of the payment card 112 comprises a payment card number printed on the payment card 112. The details of the card payment transaction includes a request ID, acquirer reference number, transaction date, a message type indicator (MTI), BIN low, a transaction amount, a function code, a processing code, reversal indicator, message reason code, acquiring institution country, a point of sale (POS) data, a universal cardholder authentication field (UCAF) indicator, a service code, transaction currency code, a merchant category code (MCC), an approval code, and a clearing product ID. The details of the card payment transaction indicates information such as whether the transaction was made with a debit card or credit card, the transaction amount, the mode in which the card payment transaction was conducted such as online transaction or in-store transaction in which the payment card 112 was physically presented, the type of goods or services purchased during the card payment transaction, merchant category, and location of the transaction (e.g., domestic or international).

The communication interface 308 is configured to receive and transmit information signals between the microservice system 300 and the outside devices such as the acquiring server 116 and the payment server 114 via the network 120. For example, the communication interface 308 sends an activation signal to the processor 304 when the I/O interface 302 receives the transaction clearing service request from the acquiring server 116. The communication interface 308 also sends an acknowledgment signal to the acquiring server 116 to indicate successful reception of the transaction clearing service request at the microservice system 300. The communication interface 308 is further configured to send an error signal or a success signal to the acquiring server 116 based on a failure or successful determination of the IRD value respectively. For example, the communication interface 308 may include an ethernet interface, a radio interface, a microwave interface, or some other type of wireless and/or wired interface. The communication interface 308 may include a transmitter and a receiver. The communication interface 308 may include a GPS receiver or a Beidou Navigation System (BNS) receiver. The communication interface 308 may support various wireless and/or wired protocols and standards. For example, the communication interface 308 may support Ultra WideBand (UWB) communication, Bluetooth, Wireless Fidelity (Wi-Fi), Transport Control Protocol/Internet Protocol (TCP/IP), Institute of Electrical and Electronics Engineers (IEEE) 802.X, Wireless Application Protocol (WAP), or any other type of wireless and/or wired protocol or standard.

The memory 306 is configured to store a computer programmable instructions executed by the processor 304 to perform the steps described herein. The memory 306 also stores the member parameter extract file published by the payment server 114.

The memory 306 also stores the at least transaction clearing service request from the at least one acquiring server 116 along with login credentials of the at least one acquiring sever 116. The memory 306 also stores a priority table that includes priority associated with each transaction clearing service request. The memory 306 also stores the at least one IRD value determined by the processor 304 in association with the respective transaction clearing service request. Examples of the memory 306 may include a non-removable memory and/or removable memory. The non-removable memory can include RAM, ROM, flash memory, or other well-known memory storage technologies. The removable memory can include flash memory and smart cards. In this example, the memory 306 is a chip (Integrated Circuit) based storage/memory.

The processor 304 receives the activation signal from the communication interface 308 that indicates reception of the at least one transaction request from the acquiring server 116. The processor 304 perform authorization of the acquiring server 116 to determine whether the acquiring server 116 is a registered member based on matching the login credentials provided by the acquiring server 116 with the login credentials stored in the memory 306. If the acquiring server 116 is a registered member the microservice system 300 accepts the transaction clearing service request and assigns a priority to the transaction clearing service request based on the priority table stored in the memory 306. The processor 304 starts analyzing the at least one transaction clearing service request stored in the memory 306 based on the priority assigned to each transaction clearing service request.

The transaction clearing service request includes details of the payment card 112 and details of the card payment transaction. The details of the payment card 112 comprises a payment card number printed on the payment card 112. The details of the card payment transaction comprises a request ID, acquirer reference number, transaction date, a message type indicator (MTI), BIN low, a transaction amount, a function code, a processing code, reversal indicator, message reason code, acquiring institution country, a point of sale (POS) data, a universal cardholder authentication field (UCAF) indicator, a service code, transaction currency code, a merchant category code (MCC), an approval code, and a clearing product ID. The details of the card payment transaction indicates information such as whether the transaction was made with a debit card or credit card, the transaction amount, the mode in which the card payment transaction was conducted such as online transaction or in-store transaction in which the payment card 112 was physically presented, the type of goods or services purchased during the card payment transaction, merchant category, and location of the transaction (e.g., domestic or international).

The processor 304 is configured to derive at least one data element from the plurality of data elements in the member parameter extract file stored in the memory 306 based on the details of the payment card 112 and the details of the card payment transaction received in the transaction clearing service request. The plurality of data elements comprises a brand product, currency codes, message reason codes, country codes, interchange amount restrictions, issuer account range, acquiring BIN, card acceptor business codes, masked interchange rate designators, masked business service, transaction functions requiring business service processing, geographical restrictions for CPI, BSA and IRD, or masked from account type.

The processor 304 is further configured to validate the at least one data element of the plurality of data elements along with the details of the payment card 112 and the details of the card payment transaction present in the transaction clearing service request. The validation of the at least one data element of the plurality of data elements along with the details of the payment card 112 and the details of the card payment transaction is based on at least one validation parameter of a first set of validation parameters.

The processor 304 is further configured to determine at least one IRD value applicable on the card payment transaction based on the derived at least one data element of the plurality of data elements along with the details of the payment card 112 and the details of the card payment transaction in the transaction clearing service request along with a plurality of business rules applicable on the card payment transaction.

The processor 304 is further configured to validate the at least one IRD value based on at least one validation parameter from a second set of validation parameters. The processor 304 is further configured to determine an optimal IRD value from the at least one IRD value. The optimal IRD value corresponds to a lowest rate IRD value from the at least one IRD value.

The processor 304 sends the optimal IRD value to the I/O interface 302 along with the acknowledgment signal indicating success to the communication interface 308.

The I/O interface 302 transmits the optimal IRD value to the acquiring server 116. The communication interface 308 transmits the acknowledgment signal indicating success to the acquiring server 116.

In an example, if the processor 304 does not find any applicable IRD value for the card payment transaction due to incorrect information provided in the transaction clearing service request, then it sends an error signal to the communication interface 308. The communication interface 308 then transmits the error signal indicating failure of determination of IRD value to the acquiring server 116 along with a reason of failure.

In an example, the processor 304 may include one or more processors, microprocessors, data processors, co-processors, network processors, application specific integrated circuits (ASICs), controllers, programmable logic devices, chipsets, field programmable gate arrays (FPGAs), and/or some other component(s) that may interpret and/or execute instructions and/or data. The processor 304 may control the overall operation of the microservice system 300 based on an operating system and/or various applications.

FIGS. 4A, 4B illustrate a flow diagram 400 representing a method of determining IRD value by the microservice 122 for each card payment transaction, in accordance with an example embodiment. The method depicted in the flow diagram 400 may be executed by a microservice such as the microservice 122 (or the microservice system 300) associated with the acquiring server 116. Operations of the flow diagram 400, and combinations of operations in the flow diagram 400, may be implemented by, for example, hardware, firmware, a processor, circuitry and/or a different device associated with the execution of software that includes one or more computer program instructions. The operations of the flow diagram 400 are described herein with help of the microservice 122, however, it is noted that such operations can be described and/or practiced by using a system other than the microservice 122, for example by the acquiring server 116 or the payment server 114, or their combination. It should further be noted that the some operations of the flow diagram 400 can be combined to be performed in a single operation and/or one operation of the flow diagram 400 may be executed in multiple steps.

At 402, the microservice 122 receives the transaction clearing service request from the acquiring server 116. The transaction clearing service request indicates a request for computing the IRD value for the card payment transaction. The transaction clearing service request comprises details of the payment card 112 and details of the card payment transaction. The details of the payment card 112 comprise a payment card number printed on the payment card 112. The details of the card payment transaction comprises, among other information, a request ID, acquirer reference number, transaction date, a message type indicator (MTI), BIN low, a transaction amount, a function code, a processing code, reversal indicator, message reason code, acquiring institution country, a point of sale (POS) data, a universal cardholder authentication field (UCAF) indicator, a service code, transaction currency code, a merchant category code (MCC), an approval code, and a clearing product ID. The details of the card payment transaction indicates information such as whether the transaction was made with a debit card or credit card, the transaction amount, the mode in which the card payment transaction was conducted such as online transaction or in-store transaction in which the payment card 112 was physically presented, the type of goods or services purchased during the card payment transaction, merchant category, and location of the transaction (e.g., domestic or international).

At 404, the microservice 122 validates the details of the payment card 112 and the details of the card payment transaction received in the transaction clearing service request based on at least one pre-defined standard such as including but not limited to ISO standards and one or more business rules followed by the payment server 114, the acquiring server 116, and the issuing server 118.

At 406, the microservice 122 identifies the MTI and the function code from the details of the payment card 112 and the details of the card payment transaction received in the transaction clearing service request.

At 408, the microservice 122 identifies acquiring country region code and issuing country region code from the details of the card payment transaction received in the transaction clearing service request and from the at least one data element i.e. country codes present in the member parameter extract file.

At 410, the microservice 122 identifies a card program identifier (CPI) and a license product ID associated with the card payment transaction. In a non-limiting example, CPI is a three-character code that identifies type of services associated with the payment card 112, for example, credit card, debit card, fleet card, ATM card, etc. and the financial network to which the card payment transaction belongs. In a non-limiting example, ‘the clearing product ID’ is a product identification three-character string given to each card which indicates information related to the facilities given to the cardholder 110 i.e. a type of card such as a debit, credit etc. and a category of card such as platinum, gold, titanium etc. The license product ID is obtained from the data element ‘brand product’ present in the member parameter extract file. The brand product data element comprises a table including license product IDs of brand products associated with each clearing product IDs assigned to each payment cards by the payment server 114.

At 412, based on the identified MTI, the function code, the acquiring country region code and the issuing country region code, the CPI and the license product ID/the clearing product ID, the microservice 122 determines whether a business service arrangement (BSA) processing is required for the given MTI and the function code combination. All the operations allowed between the acquiring server 116 and the issuing server 118 are defined by the BSA. When the acquiring server 116 and the issuing server 118 get registered within the payment server 114, the payment server 114 defines business agreements with the acquiring server 116 and the issuing server 118, and these business agreements are called business service arrangements (BSA). The payment server 114 has ‘n’ number of business operation regions and each business operation region follows certain business rules. In a non-limiting example, BSA can be categorized in five types based on business operation regions and countries, as given below:
1. Customer-to-Customer: pair or group of customers with specific business relationship.
2. Intra country: customers in same country.
3. Inter country: customers in multiple countries or business regions.
4. Intra-regional: customers in same business region.
5. Inter-regional: customers in different business regions.

Accordingly, the microservice 122 determines one or more BSAs (e.g., BSAa, BSAb, BSAc) associated with the identified CPI applicable on the card payment transaction based on the at least one data element of the member parameter extract file, the details of the payment card 112 and the details of the card payment transaction.

At 414, the microservice 122 selects a BSA (e.g., BSAa, BSAb, BSAc) associated with the CPI based on a BSA priority associated with each BSA, and further the microservice determined IRD values for the selected BSAs by performing operations 416 to 424. For example, the first BSA i.e. the BSAa is selected, and for the selected BSA, operations 416 to 424 are performed.

At 416, the microservice 122 identifies whether there is masking for the CPI and the selected BSA. Masking is a process of overriding few digits or characters present in a number, string or code such as account number, CPI, BSA etc. to indicate additional information associated with the CPI and the BSA or the account type. If the masked CPI and BSA is available, then the microservice considered the masked CPI and BSA for the computation of IRD value otherwise the original CPI and BSA identified from the transaction clearing service request will be used for the computation.

Further, the method includes validating the selected BSA based on a first set of parameters as indicated in operations 416 to 424. It should be noted that the validation of the BSA associated with the identified CPI is performed, where the CPI and the BSA can either be the masked CPI and BSA or the original CPI and BSA.

At 418, for the validation of the BSA, the microservice 122 validates a reversal indicator for the message reason code to determine whether it's a reversal transaction or an original transaction. In an example, the message reason code for the original transaction includes four spaces as code. If the reversal indicator is invalid, the microservice 122 terminates the validation of the current BSA and the method proceeds to operation 414 where the next BSA for example, BSAb is selected for validation. The next BSA may also be selected based on the BSA priority given to each BSA of the plurality of BSAs associated with the CPI. However, if the reversal indicator is valid, the method proceeds to 420.

At 420, after completion of the validation of the message reason code, the microservice 122 fetches information related to masking of the account type of the cardholder 110. The account type corresponds to one of a current account, a savings account or a default account. In some instances, the account type can be masked. If the microservice 122 identifies that the account type is masked then the masked account type will be used for further computation of the IRD value otherwise original account type which was received in the transaction clearing service request will be used.

At 422, the microservice 122 further validates the BSA by validating the reversal indicator for the account type of the cardholder 110. If the reversal indicator for the account type is invalid the microservice 122 terminates the validation of the current BSA and the method proceeds to operation 414 where the next BSA for example, BSAb is selected for validation. However, if the reversal indicator is valid, the method proceeds to 424.

At 424, the microservice 122 derives at least one transaction category based on the POS data, the UCAF indictor, and the service code. The at least one transaction category is directly not provided in any of the member parameter extract files published by the payment server 114, but transaction category is derived from information present in manuals provided by the payment server 114. In an example, the POS data is 12-character value, the UCAF indicator is a three-character value, and the service code is a three-digit value. The UCAF indicator is used in e-commerce transactions and indicates capability of both the acquiring institution and the issuing institution such as support for 3D secure payment gateway and the like. The service code indicates services entitled to the payment card 112. Guidelines to compute transaction category are in synchronization with classification criteria present in the manuals provided by the payment server 114 to decide the at least transaction category. For each merchant category code, a set of transaction categories may be applicable. The at least one transaction category depends on multiple factors such as the type of goods or service purchased during the card payment transaction, the type of transaction such as purchase, money send, or whether the transaction was a contactless transaction or e-commerce transaction etc.

At 426, the microservice 122 determines at least one IRD value based on the BSA, CPI, MTI, the processing code, the function code, and the transaction category combination. Accordingly, for the selected BSA i.e. the BSAa, at least one IRD value for example, IRD1a, IRD2a, IRD3 a, are determined. For example, the IRD1a can be determined for a first combination including BSA, CPI, MTI, processing code, function code, and transaction category 1, the IRD2a can be determined for a second combination including BSA, CPI, MTI, processing code, function code, and transaction category 2, and the IRD3a can be determined for a third combination including BSA, CPI, MTI, processing code, function code, and transaction category 3,

At 428, an IRD value from the at least one IRD value is selected based on a product class priority associated with the clearing product ID, and validation of the selected IRD value based on a second set of parameters is performed as per the operation 430 to 442. If validation of the IRD value fails for any of the second set of parameters, a next IRD value is selected.

At 430, the microservice 122 validates IRD value based on whether the card payment transaction is allowed for the identified CPI, the BSA, the MTI, the function code, the processing code and the IRD value combination. If the validation fails then the microservice 122 terminates the validation of the current IRD value, and proceeds to operation 428 to select next IRD value of the at least one IRD value for validation purposes. The next IRD value is selected based on the product class priority. If the validation at operation 430 is successful, the method proceeds to 432.

At 432, the microservice 122 validates the approval code required for the CPI, the BSA, the MTI, the function code, the processing code and IRD combination. If the validation fails then the microservice 122 terminates the validation of the current IRD value, and proceeds to operation 428 to select next IRD value of the at least one IRD value for validation purposes. If the validation at operation 432 is successful, the method proceeds to 434.

At 434, the microservice 122 check if transaction amount falls in predetermined range for example a low value range or large ticket amount limits for the CPI and the BSA based on the plurality of parameters in the transaction clearing service request. If the transaction value falls in the low or large ticket amount, then a predetermined base IRD value is considered as the IRD value otherwise algorithm proceeds with next IRD value of the at least one IRD value.

At 436, the microservice 122 check the transaction clearing service request to determine if any masked IRD value exist for the derived IRD value. If masked IRD value is found, it is used for next validations.

At 438, the microservice 122 validates whether the license product ID/the clearing product ID is valid for the CPI, the BSA and the IRD value combination. If the validation fails at operation 440, the microservice 122 terminates the validation of the current IRD value, and proceeds to operation 428 to select next IRD value of the at least one IRD value for validation purposes. If the validation at operation 438 is successful, the method proceeds to 440.

At 440, the microservice 122 validates whether MCC program is valid for the given CPI, the BSA and the IRD value combination, based on the details of the card payment transaction in the transaction clearing service request. If the validation fails at operation 442, the microservice 122 terminates the validation of the current IRD value, and proceeds to operation 428 to select next IRD value (i.e. for next transaction category) of the at least one IRD value for validation purposes based on the product class priority. If the validation at operation 440 is successful, the method proceeds to 442.

If at least one IRD value is determined then the microservice 122 determines at operation 442 whether there is a time delay in submission of the transaction clearing service request by the acquiring server 116. If there is time delay in submission of the transaction clearing service request by the acquiring server 116 then a delayed IRD value is calculated based on the corresponding IRD value. In an embodiment, the microservice 122 creates a static table including delayed optimal IRD values placed in association with the optimal IRD value in accordance with the time delay in submission of transaction clearing service request by the acquiring server 116.

At 444, the microservice 122 determines whether the IRD value is null or a definite value of IRD is obtained for the selected IDR value. If the IRD value is not null, the microservice 122 derives the IRD value at operation 446, and sends the obtained IRD value to the acquiring server 116 at operation 454.

At 444, if IRD value is null i.e. IRD value cannot be derived for the transaction category, the method proceeds to operation 448, where it is checked if validation of all IRDs (e.g., IRD1a, IRD2a, IRD3a) are performed for the second set of parameters.

If all IRDs are not validated, the method proceeds to 428, where the next IRD is selected. For instance, once the IRD1a is validated for the second set of parameters, and null result is obtained (e.g., validation fails), the next IRD combination for example, IRD2a is selected, and the operations 430 to 442 are performed. In an example, if the validation of the IRD2a also fails for the second set of parameters, the next IRD combination for example, IRD3a is selected for validation purposes.

At operation 448, if it is determined that validation of all IRD combinations are performed for the second set of parameters, the method proceeds to 450.

At operation 450, it is checked if all of the BSAs are selected at operation 416. If all BSAs (e.g., BSAa, BSAb, BSAc) are not selected i.e. the first set of parameters and second set of parameters are not checked for all BSAs, the next BSA is selected. For example, in the first pass, BSAa is selected, and BSAa is validated for the first set of parameters in operations 416 to 424, and operations 430 to 442 are performed for validations of all IRD combinations determined for the BSAa for the second set of parameters. If the result is null at the end of the first pass, i.e. there could not be any valid IRD value determined for the BSAa, next BSA i.e. the BSAb is selected. In this example, in the second pass BSAb is validated for the first set of parameters in operations 416 to 424, and operations 430 to 442 are performed for validations of all IRD combinations determined for the BSAb for the second set of parameters. If the result is null at the end of the second pass, i.e. there could not be any valid IRD value determined for the BSAb, next BSA i.e. the BSAc is selected. In this example, in the third pass, BSAc is validated for the first set of parameters in operations 416 to 424, and operations 430 to 442 are performed for validations of all IRD combinations determined for the BSAc for the second set of parameters.

Further, if it is determined that all the BSAs are considered for the determination of the IRD value and yet IRD value cannot be determined then an error message (or signal) will be generated indicating failure in determination of the IRD value at operation 452.

In some embodiments, once a valid IRD value is obtained for any BSA, the method terminates and the valid IRD value is provided to the acquiring server 116. However, in some embodiments, all of the valid IRD values are computed for all BSAs determined at operation 412. Thereafter, the method determines an optimal IRD value among the at least one IRD value derived at step 446. The optimal IRD value may corresponds to a minimum value among the at least one IRD value.

At 454, the microservice 122 sends the optimal IRD value to the acquiring server 116, and the acquiring server 116 computers the interchange fee based on the optimal IRD value.

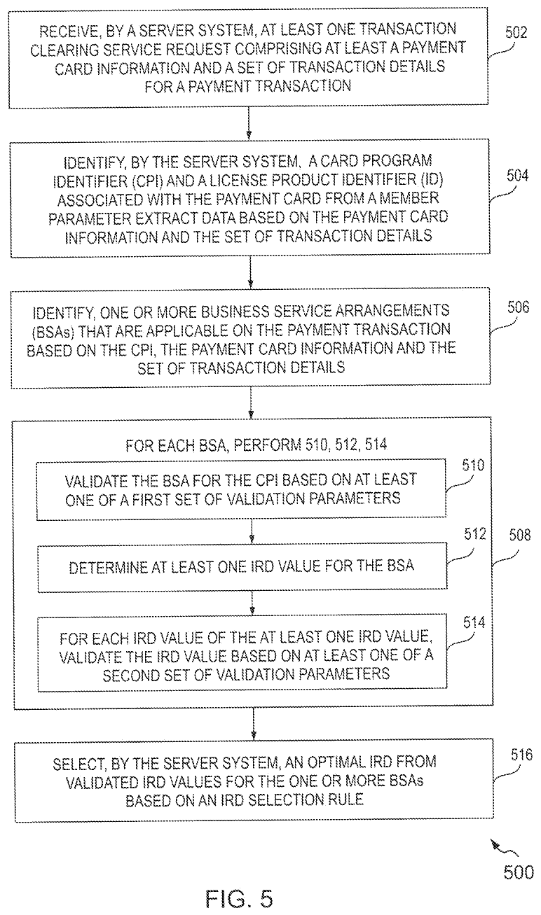

FIG. 5 illustrates a flow diagram of a method 500 for calculation of IRD value, in accordance with another example embodiment of present disclosure. The method 500 depicted in the flow diagram may be executed by a microservice such as the microservice 122 (or the microservice system 300) associated with the acquiring server 116. Operations of the flow diagram of the method 500, and combinations of operations in the flow diagram, may be implemented by, for example, hardware, firmware, a processor, circuitry and/or a different device associated with the execution of software that includes one or more computer program instructions. The operations of the method 500 are described herein with help of the microservice 122, however, it is noted that the operations of the method 500 can be described and/or practiced by using a system other than the microservice 122, for example by the acquiring server 116 or the payment server 114 or their combination. It should further be noted that the some operations of the method 500 can be combined to be performed in a single operation and/or one operation of the method 500 may be executed in multiple steps.

At 502, the microservice receives at least one transaction clearing service request from the acquiring server 116, where the transaction clearing service request includes payment card information and a set of transaction details for a payment transaction.

At 504, the microservice identifies a card program identifier (CPI) and a license product identifier (ID) associated with the payment card from a member parameter extract (MPE) data based on the payment card information and the set of transaction details present in the transaction clearing service request.

At 506, the microservice is configured to identify one or more business service arrangements (e.g., BSAa, BSAb, BSAc etc.) that are applicable on the payment transaction based on the CPI, the payment card information and the set of transaction details.

The microservice performs the operation 508 for each of the BSAs identified that are applicable on the payment transaction in a sequential manner or in parallel manner. The operation 508 includes operations 510, 512 and 514.

At 510, a BSA (e.g., BSAb) is validated for the CPI based on at least one of a first set of validation parameters. Examples of the first set of validation parameters are provided with reference to FIG. 4. Validations of the BSAs may be performed in a sequential manner, and/or in a parallel manner.

At 512, if the selected BSA is successfully validated based on the first set of parameters, applicable IRDs for the selected BSA are determined. Further, at operation 514, for each IRD of the applicable IRDs, it is checked if the IRD is valid based on certain parameters. In an embodiment, all of the IRD values that are possible for identified BSAs, are validated based on a second set of validation parameters, and multiple IRD values are derived based on results of the validation process. In an example embodiment, all of the validated IRDs are collected for all of the BSAs identified at operation 506. In another example embodiment, once a valid IRD is obtained, the operation 508 ends, and the method 500 proceeds to operation 516.

At 516, from the multiple validated IRD values, an optimal IRD value may be selected for one or more BSAs based on an IRD selection rule. An example of the rule includes selecting the IRD value which provides the minimum interchange fee for the acquirer.

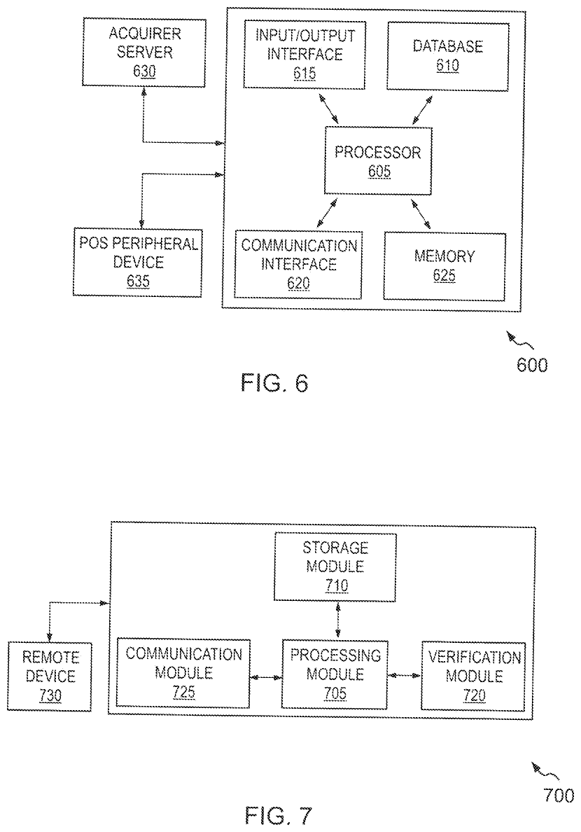

Referring now to FIG. 6, a simplified block diagram of a merchant terminal 600 such as the POS terminal 104 used for calculation of IRD value for a card based payment transaction, in accordance with one embodiment of the present disclosure. The merchant terminal 600 as explained herein is only one example of the POS terminal 104. In various embodiments, the merchant terminal 600 can be a merchant mobile phone, a kiosk, a PDA, a merchant facilitated e-commerce website interface running on a computing device and the like. The merchant terminal 600 includes at least one processor 605 communicably coupled to a database 610, an Input/Output (I/O) interface 615, a communication interface 620 and a memory 625. The components of the merchant terminal 600 provided herein may not be exhaustive, and that the merchant terminal 600 may include more or fewer components than that of depicted in FIG. 6. Further, two or more components may be embodied in one single component, and/or one component may be configured using multiple sub-components to achieve the desired functionalities. Some components of the merchant terminal 600 may be configured using hardware elements, software elements, firmware elements and/or a combination thereof.

An I/O interface 615 is configured to receive inputs from and provide outputs to the end-user (i.e. the merchant and/or the customer) of the merchant terminal 600. For instance, the I/O interface 615 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 625 can be any type of storage accessible to the processor 605. For example, the memory 625 may include volatile or non-volatile memories, or a combination thereof. In some non-limiting examples, the memory 625 can be four to sixty four MegaBytes (MB) of Dynamic Random Access Memory (“DRAM”) or Static Random Access Memory (“SRAM”). In addition, some examples may include supplementary flash memory installed via a PCMCIA slot.

The database 610 is capable of storing and/or retrieving data, such as, but not limited to, smart card insertions, user/customer information, merchant information, payment strings uniquely associated with each user, touch-screen key depressions, keypad key depressions, number of dots printed by the slip and roll printers, check read errors, card swipes, such as, plurality of number pad values of the payment card and the like. Such information can be accessed by the processor 605 using the communication interface 620 to determine potential future failures and the like.

The merchant terminal 600 is capable of communicating with one or more POS peripheral devices such as a POS peripheral device 635 and external server system such as an acquiring server 630 (an example of the acquiring server 116 of FIG. 1) via the communication interface 620. The POS peripheral device 635 can provide functionality which is used by a consumer at a merchant facility, such as PIN entry, merchant transaction amount entry, clear text entry, signature capture, and the like. Some non-exhaustive examples of the POS peripheral device 635 include POS card reader device, barcode scanner, cash drawer, receipt printer, PIN pad, signature capture device, touchscreen, keyboard, portable data terminal, customer pole display and the like. In some embodiments, the merchant terminal 600 may be mounted near a cash register at a check-out counter in the merchant facility, while the POS peripheral device 635 may be mounted on the check-out counter such that it is accessible to the users. In this way, both the merchant and the user/customer can interact with similar devices to process the payment transaction.

The communication interface 620 is further configured to cause display of user interfaces on the merchant terminal 600. In one embodiment, the communication interface 620 includes a transceiver for wirelessly communicating information to, or receiving information from, the acquiring server 630 or other suitable display device, and/or another type of remote processing device. In another embodiment, the communication interface 620 is capable of facilitating operative communication with the remote devices and a cloud server using Application Program Interface (API) calls. The communication may be achieved over a communication network.

The processor 605 is capable of sending the transaction request received from the end-user via the communication interface 620 to the acquiring server 630 for processing the transaction. For example, the processor 605 is configured to receive the payment card information of the cardholder 110, PIN and the transaction amount via the POS peripheral device 635. The processor 605 can access the database 610 to retrieve the user information and merchant information that are required to be sent along with the transaction request to the acquiring server 630.

Additionally, the merchant terminal 600 can include an operating system and various software applications that can provide various functionality to the merchant terminal 600. For example, in some embodiments, the merchant terminal 600 is addressable with an Internet protocol and includes a browser application. In such embodiments, the processor 605 includes software adapted to support such functionality. In some embodiments, the processor 605 executes software to support network management. In particular, this capacity allows software to be downloaded to a plurality of such systems to provide new applications such as application for enabling payment string based payment transactions using POS terminals and/or updates to existing applications. The operating system and software application upgrades are distributed and maintained through communication to the merchant terminal 600 over the communication network.

Referring now to FIG. 7, a simplified block diagram of an issuing server 700, in accordance with one embodiment of the present disclosure. The issuing server 700 is an example of the issuing server 118 of FIG. 1 or may be embodied in the issuing server 118. The issuing server 700 is associated with an issuer bank/issuer, in which a cardholder may have an account, which provides a payment card. The issuing server 700 includes a processing module 705 operatively coupled to a storage module 710, a verification module 720 and a communication module 725. The components of the issuing server 700 provided herein may not be exhaustive and that the issuing server 700 may include more or fewer components than that of depicted in FIG. 7. Further, two or more components may be embodied in one single component, and/or one component may be configured using multiple sub-components to achieve the desired functionalities. Some components of the issuing server 700 may be configured using hardware elements, software elements, firmware elements and/or a combination thereof.

The storage module 710 is configured to store machine executable instructions to be accessed by the processing module 705. Additionally, the storage module 710 stores information related to, contact information of the customer, bank account number, availability of funds in the account, payment card details, and/or the like. This information is retrieved by the processing module 705.

The processing module 705 is configured to communicate with one or more remote devices such as a remote device 730 using the communication module 725 over a network such as the network 120 of FIG. 1. The examples of the remote device 730 include the merchant terminal 104, the payment server 114, the acquiring server 116 and the network 120 and the like. The communication module 725 is capable of facilitating such operative communication with the remote devices and cloud servers using API (Application Program Interface) calls. The communication module 725 is configured to receive a registration request for using services of the microservice 122. The communication module 725 is configured to receive a transaction clearing service request from the acquiring server 116 via the network 120. In some example embodiments, the processor 605 is configured to receive the transaction clearing service request from the acquiring server 116.

The verification module 720 is configured to verify and validate a customer (such as the cardholder 110), the payment card 112 associated with the cardholder 110 and a PIN of the payment card 112 for approving the transaction. The verification module 720 may also verify if an issuer account of the customer associated with the payment card 112 have good standing balance. The communication module 725 is configured to send notification of approval or decline of a transaction to the merchant terminal 104 via the network 120.

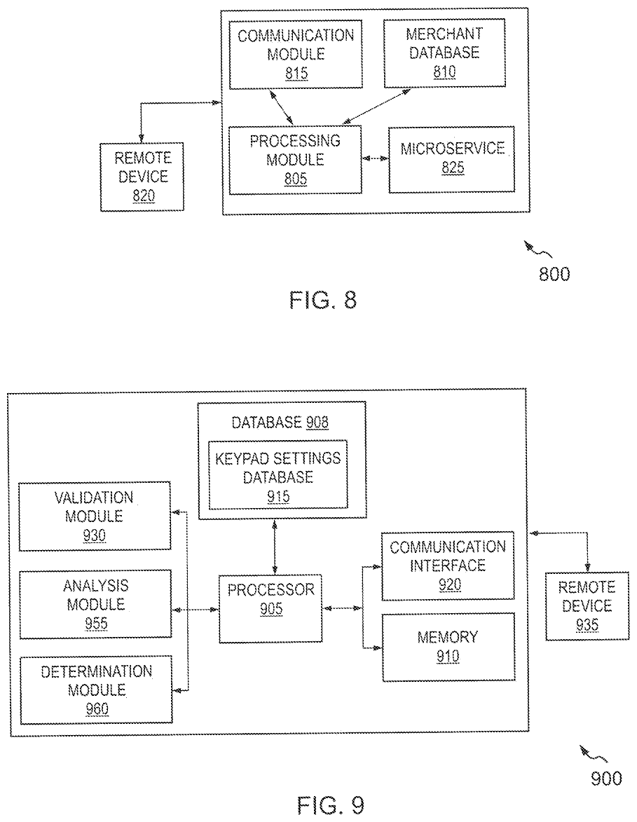

Referring now to FIG. 8, a simplified block diagram of an acquiring server 800 used for calculation of IRD value for a card based payment transaction, in accordance with one embodiment of the present disclosure. The acquiring server 800 is associated with an acquirer bank, which may be associated with a merchant (e.g., the merchant facility 102) at whose facility the cardholder 110 is purchasing goods. The merchant may have established an account to accept payment for purchase of goods from customers. The acquiring server 800 is an example of the acquiring server 116 of FIG. 1 or may be embodied in the acquiring server 116. Further, the acquiring server 800 is configured to facilitate transaction with the issuing server 700 using a network, such as the network 120 of FIG. 1. The acquiring server 800 includes a processing module 805 communicably coupled to a merchant database 810 and a communication module 815. The components of the acquiring server 800 provided herein may not be exhaustive, and that the acquiring server 800 may include more or fewer components than that of depicted in FIG. 7. Further, two or more components may be embodied in one single component, and/or one component may be configured using multiple sub-components to achieve the desired functionalities. Some components of the acquiring server 800 may be configured using hardware elements, software elements, firmware elements and/or a combination thereof.

The merchant database 810 includes a table which stores one or more merchant parameters, such as, but not limited to, a merchant primary account number (PAN), a merchant name, a merchant ID (MID), a merchant category code (MCC), a merchant city, a merchant postal code, an MAID, a merchant brand name, terminal identification numbers (TIDs) associated with merchant terminals (e.g., the POS terminals or any other merchant electronic devices) used for processing transactions, among others. The processing module 805 is configured to use the MID or any other merchant parameter such as the merchant PAN to identify the merchant during the normal processing of payment transactions, adjustments, chargebacks, end-of-month fees, loyalty programs associated with the merchant and so forth. The processing module 805 may be configured to store and update the merchant parameters in the merchant database 810 for later retrieval. In an embodiment, the communication module 815 is capable of facilitating operative communication with a remote device 820.

In some embodiments, the acquiring server 800 includes a microservice 825, which may be an example of the microservice 122 described with reference to FIGS. 1 and 3. In an example embodiment, an instance of the microservice 825 may be provided by the payment server 114 for deploying the microservice 825 in the acquiring server 800. Optionally, the microservice 825 may be configured to communicate with the POS terminal 600 using the communication module 815. Once the microservice 825 calculates the optimal IDR, the optimal IRD is provided to the payment server 114.

FIG. 9 is a simplified block diagram of a payment server 900 used for facilitating calculation of IRD values in card based payment transaction, in accordance with one embodiment of the present disclosure. The payment server 900 may correspond to the payment server 114 of FIG. 1. The network 120 may be used by the payment server 900, the issuing server 700 and the acquiring server 800 as a payment interchange network. Examples of payment interchange network include, but not limited to, Mastercard® payment system interchange network. The payment server 900 includes a processor 905 configured to extract programming instructions from a memory 910 to provide various features of the present disclosure. The components of the payment server 900 provided herein may not be exhaustive and that the payment server 900 may include more or fewer components than that of depicted in FIG. 9. Further, two or more components may be embodied in one single component, and/or one component may be configured using multiple sub-components to achieve the desired functionalities. Some components of the payment server 900 may be configured using hardware elements, software elements, firmware elements and/or a combination thereof.

Via a communication interface 920, the processor 905 receives a transaction request from a remote device 935 such as the acquiring server 800 or the merchant terminal 104. The communication may be achieved through API calls, without loss of generality. A keypad settings database 915 is embodied in a database 908 of the payment server 900. The keypad settings database 915 stores information corresponding to a customized electronic number pad settings of an electronic number pad from a plurality of customers. The keypad settings database 915 is in operative communication with a validation module 930, an analysis module 955, a determination module 960 and a comparison module 965.

The determination module 960 is configured to receive a plurality of IRD values associated with a plurality of card payment transactions done using the payment card 112 via the communication interface 920. The determination module 960 is configured to determine an interchange fee applicable for each IRD value of the plurality of IRD values. In some embodiments, the analysis module 955 receives the plurality of IRD values associated with a plurality of card payment transactions done using the payment card 112 via the communication interface 920. The analysis module 955 is configured to determine an interchange fee applicable for each IRD value of the plurality of IRD values.

The memory 910 stores details such as Issuer ID, POS ID, country code, acquirer ID, payment card details, acquirer account information, transaction records, merchant account information, and the like. The customer details, the payment card details, the issuer account balance, etc. are validated using the validation module 930. The validation module 930 may include one or more predefined rule sets using which the processor 905 can process the validation. Further, the processor 905, upon successful validation, sends interchange fee to the acquiring server 800 and credits the issuing server 700 with the interchange fee.

The processor 905 is further configured to notify the remote device 935 of the transaction status via the communication interface 920. The remote devices, as an example, may be the merchant terminal 104, the merchant interface device 106, and the acquiring server 116. In one embodiment, the processor 905 may facilitate a dedicated software application (also referred to as ‘the application interface’) capable of being installed on the acquiring server 116. The acquiring server 800 (e.g., the acquiring server 116) may access the application interface for registration and request for the IRD values. The acquiring server 800 may access the application interface using a web link as well, instead of having a need to install the application on the acquiring server 800.

Without in any way limiting the scope, interpretation, or application of the claims appearing below, a technical effect of one or more of the example embodiments disclosed herein is to provide methods and systems for determination of IRD value for payment transactions with a payment card of a customer. More specifically, a microservice is rendered at the acquiring server for the determination of the IRD values accurately and faster which helps the acquiring servers to submit correct IRD values in timely manner and hence preventing any financial loss incurred because of late or incorrect submission of IRD value to the payment servers. Further, the limitation of availability of the details of the card payment transaction along with member parameter extract data at the microservice quickens the process of determination of IRD values as time invested in fetching data is reduced. Further, the microservice is a unified service available across all the acquiring banks for the determination of IRD values which also globalizes the process of determination of IRD values across all the regions. Moreover, simultaneous determination of IRD values further makes the process faster. By implementing such additional steps for determining the IRD values, makes the process accurate, faster and financial efficient.

The disclosed methods with reference to FIGS. 1 to 9, or one or more operations of the flow diagrams 400 and 500 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server systems (e.g., the servers 114, 116 and 118) and its various components such as the computer system and the database may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method of computing interchange rate designator (IRD) value for interchange rate processing in payment transactions, the method comprising:
receiving, by a server system, at least one transaction clearing service request comprising at least a payment card information and a set of transaction details for a payment transaction of a payment card;
identifying, by the server system, a card program identifier (CPI) and a license product identifier (ID) associated with the payment card from a member parameter extract data based on the payment card information and the set of transaction details;
identifying one or more business service arrangements (BSAs) that are applicable on the payment transaction based on the CPI, the payment card information and the set of transaction details;
for each BSA of the one or more BSAs, by the server system, performing
validating the BSA for the CPI based on at least one of a first set of validation parameters;
upon successful validation, determining at least one IRD value for the BSA, and
for each IRD value of the at least one IRD value performing
validating the IRD value based on at least one of a second set of validation parameters; and
selecting, by the server system, an optimal IRD value from validated IRD values for the one or more BSAs based on an IRD selection rule.

2. The method according to claim 1, further comprising receiving the member parameter extract data from a payment server,
wherein the member parameter extract data comprises at least one of a brand product, country codes, currency codes, message reason code, issuer account range, acquiring bank identification number (BIN), card acceptor business (CAB) codes, masked IRDs, masked business service arrangement, transaction functions requiring business service processing, geographical restrictions for CPI, BSA and IRD, and masked account type, and
wherein the set of transaction details comprises at least one of a message type indicator (MTI), a transaction date, a transaction amount, a merchant category code, a function code, a processing code, a point of sale (POS) data, a universal cardholder authentication field (UCAF) indicator, a service code, an acquiring institution country, a clearing product ID and an approval code.

3. The method according to claim 2, further comprising:
identifying an acquiring country region code and an issuing country region code from the member parameter extract data;
generating the license product ID corresponding to the clearing product ID based on mapping of the identified clearing product ID with a plurality of license product IDs stored in a table present in the member parameter extract data; and
deriving a transaction category based on the POS data, the UCAF indicator and the service code.

4. The method according to claim 3, wherein determining the at least one IRD value for the one or more BSAs is based on the CPI, the license product ID/the clearing product ID, the acquiring country region code, the issuing country region code, and the transaction category, and
wherein the IRD selection rule comprises selecting a lowest rate IRD value from the at least one IRD value.

5. The method according to claim 1, wherein the first set of validation parameters comprising validating a reversal indicator for a message reason code, wherein the reversal indicator indicates whether the payment transaction is a reversal transaction or an original transaction.

6. The method according to claim 5, further comprising identifying a masked account type based on presence of at least one overriding digit in an account number of a cardholder.

7. The method according to claim 6, wherein the first set of validation parameters further comprises: validating the reversal indicator for the masked account type; and validating the reversal indicator for an original account type received in the at least one transaction clearing service request.

8. The method according to claim 3, wherein the second set of validation parameters comprises:
validating whether the payment transaction is allowed for a combination of the CPI, the BSA, the MTI, the function code, the processing code and the IRD value;
validating an approval code required for the combination of the CPI, the BSA, the MTI, the function code, the processing code and the IRD value;
identifying a transaction amount range of the payment transaction that falls in a predetermined range;
identifying whether the license product ID/the clearing product ID is valid for a combination of the CPI, the BSA, and the IRD value; and
identifying whether the merchant category code is valid for the combination of the CPI, the BSA and the IRD value.

9. The method according to claim 1, further comprising:
identifying if there is a delay in reception of the at least one transaction clearing service request based on late submission of the at least one transaction clearing service request by an acquiring server;
upon identifying the delay, computing a delayed IRD value corresponding to the optimal IRD value and a base IRD value; and
provide at least one of the delayed IRD value and the optimal IRD value to a payment server for computation of an interchange fee.

10. A method of computing interchange rate designator (IRD) value for interchange rate processing, the method comprising:
receiving, by a server system, at least one transaction clearing service request comprising at least a payment card information and a set of transaction details for a payment transaction of a payment card;
identifying, by the server system, a card program identifier (CPI) and a license product identifier (ID) associated with the payment card from a member parameter extract data based on the payment card information and the set of transaction details;
identifying one or more business service arrangements (BSAs) that are applicable on the payment transaction based on the CPI, the payment card information and the set of transaction details;
for each BSA of the one or more BSAs, by the server system, performing
validating the BSA for the CPI based on at least one of a first set of validation parameters;
upon successful validation, determining at least one IRD value for the BSA, and
for each IRD value of plurality of IRD values, performing
validating the IRD value based on at least one of a second set of validation parameters;
identifying if there is a delay in reception of a transaction clearing service request based on late submission of the transaction clearing service request;
computing a delayed IRD value for the IRD value based on the delay in reception of the transaction clearing service request; and
selecting, by the server system, an optimal IRD value from one of the validated IRD values and the delayed IRD values for the one or more BSAs based on an IRD selection rule.

11. The method according to claim 10, further comprising receiving the member parameter from a payment server on a periodic basis,
wherein the member parameter extract data comprises at least one of a brand product, country codes, currency codes, a message reason code, issuer account range, acquiring bank identification number (BIN), card acceptor business (CAB) codes, masked IRDs, masked business service arrangement, transaction functions requiring business service processing, geographical restrictions for CPI, BSA and IRD, and a masked account type, and
wherein the set of transaction details comprises at least one of a message type indicator (MTI), a transaction date, a transaction amount, a merchant category code, a function code, a processing code, a point of sale (POS) data, a universal cardholder authentication field (UCAF) indicator, a service code, an acquiring institution country, a clearing product ID and an approval code.

12. The method according to claim 11, further comprising:
identifying an acquiring country region code and an issuing country region code from the member parameter extract data;
identifying the license product ID corresponding to the clearing product ID based on mapping of the identified clearing product ID with a plurality of license product IDs stored in a table present in the member parameter extract data; and
deriving a transaction category based on the POS data, the UCAF indicator and the service code.

13. The method according to claim 11, wherein determining the at least one IRD value for the one or more BSAs is based on the CPI, the license product ID/the clearing product ID, the acquiring country region code, the issuing country region code, and the transaction category.

14. The method according to claim 10, wherein the first set of validation parameters comprising:
validating a reversal indicator for a message reason code, wherein the reversal indicator indicates whether the payment transaction is a reversal transaction or an original transaction; and
validating the reversal indicator for a masked account type otherwise validating the reversal indicator for an original account type received in the at least one transaction clearing service request.

15. The method according to claim 10, wherein the second set of validation parameters comprising:
validating whether the payment transaction is allowed for a combination of the CPI, the BSA, the MTI, the function code, the processing code and the IRD value;
validating an approval code required for the combination of the CPI, the BSA, the MTI, the function code, the processing code and the IRD value;
identifying a transaction amount range of the payment transaction that falls in a predetermined range;
identifying whether the license product ID/the clearing product ID is valid for a combination of the CPI, the BSA, and the IRD value; and
identifying whether the merchant category code is valid for the combination of the CPI, the BSA and the IRD value.

16. A microservice system for performing interchange rate processing related to a payment transaction initiated by a cardholder with a merchant using a payment card, the microservice system comprising:
a memory to store instructions; and
at least one processor, configured to execute the stored instructions to cause the microservice system to perform at least
receiving at least one transaction clearing service request comprising at least a payment card information and a set of transaction details for the payment transaction,
identifying a card program identifier (CPI) and a license product identifier (ID) associated with the payment card from a member parameter extract data based on the payment card information and the set of transaction details,
identifying one or more business service arrangements (BSAs) that are applicable on the payment transaction based on the CPI, the payment card information and the set of transaction details,
for a BSA of the one or more BSAs performing
validating the BSA for the CPI based on at least one of a first set of validation parameters,
upon successful validation, determining at least one IRD value for the BSA, and
for an IRD value of at least one IRD value, performing
validating the IRD value based on at least one of a second set of validation parameters, and
selecting an optimal IRD value from validated IRD values for the one or more BSAs based on an IRD selection rule.

17. The microservice system as claimed in claim 16, further caused at least in part to receive the member parameter extract data from a payment server,
wherein the set of transaction details comprises at least one of a message type indicator (MTI), a transaction date, a transaction amount, a merchant category code, a function code, a processing code, a point of sale (POS) data, a universal cardholder authentication field (UCAF) indicator, a service code, an acquiring institution country, a clearing product ID and an approval code, and
wherein the member parameter extract data comprises at least one of a brand product, country codes, currency codes, message reason codes, issuer account range, acquiring bank identification number (BIN), card acceptor business (CAB) codes, masked IRDs, masked business service arrangement, transaction functions requiring business service processing, geographical restrictions for CPI, BSA and IRD, and a masked account type.

18. The microservice system as claimed in claim 17, further caused at least in part to:
identify an acquiring country region code and an issuing country region code from the member parameter extract data;
identify the license product ID corresponding to the clearing product ID based on mapping of the identified clearing product ID with a plurality of license product IDs stored in a table present in the member parameter extract data; and
derive a transaction category based on the point of sale (POS) data, the universal cardholder authentication field (UCAF) indicator and the service code.

19. The microservice system as claimed in claim 18, further caused at least in part to:
identify if there is a delay in reception of the at least one transaction clearing service request based on late submission of the transaction clearing service request by an acquiring server;
upon identifying the delay, compute a delayed IRD value corresponding to the optimal IRD value and a base IRD value; and
provide one of the delayed IRD value and the optimal IRD value to a payment server for computation of an interchange fee.

20. The microservice system as claimed in claim 17,
wherein the first set of validation parameters comprising:
validating a reversal indicator for a message reason code, wherein the reversal indicator indicates whether the payment transaction is a reversal transaction or an original transaction; and
validating the reversal indicator for a masked account type otherwise validating the reversal indicator for an original account type received in the at least one transaction clearing service request, and
wherein the second set of validation parameters comprising:
validating whether the payment transaction is allowed for a combination of the CPI, the BSA, the MTI, the function code, the processing code and the IRD value;
validating an approval code required for the combination of the CPI, the BSA, the MTI, the function code, the processing code and the IRD value;
identifying a transaction amount range of the payment transaction that falls in a predetermined range;
identifying whether the license product ID/the clearing product ID is valid for a combination of the CPI, the BSA, and the IRD value; and
identifying whether the merchant category code is valid for the combination of the CPI, the BSA and the IRD value.
